(19) United States
(12) Patent Application Publication
(10) Pub. No.: US 2004/0076731 A1
(43) Pub. Date: Apr. 22, 2004

(54) Powdered fat composition and products made thereof

(76) Inventor: Neil Joseph Bourke, Almere-Haven (NL)

Correspondence Address: FITCH EVEN TABIN AND FLANNERY, 120 SOUTH LA SALLE STREET, SUITE 1600, CHICAGO, IL, 60603-3406, US

(21) Appl. No.: 10/451,276

(22) PCT Filed: Dec. 20, 2001
(86) PCT No.: PCT/NL01/00928

(30) Foreign Application Priority Data
Dec. 20, 2000 (EP) 00204657.1

(51) Int. Cl. A23D 7/00

(52) U.S. Cl. 426/601

(57) ABSTRACT

The invention relates to a powdered fat composition comprising 10-80 wt. % crystallising fat, 0.5-15 wt. % of one or more proteins, 0.3-20 wt. % emulsifier, 1-4 wt. % water and the balance is made up of carbohydrates(s) as well as optionally 0-10 wt. % of a stabiliser, gelling agent, thickener, processing acid or a mixture thereof. The above powdered fat composition can be converted in a low fat spread having a water content of 50-90 wt %, preferably 60-85 wt. % by hydrating the powdered fat composition with cold water or other aqueous based liquid and cooling the obtained hydrated product to refrigeration temperatures resulting in a material having a final texture of a plastic solid with a hardness of 180-220 gram measured on a Stevens texture analyser. Dips, mousse, pates and food based cosmetic preparations are some of the other applications, which demonstrate the versatility of the said fat composition in both hot and cold applications.

Complicated processes coupled to long ingredient lists are typical of many classical food products. It has been found that there is a requirement from food manufacturers and food preparers for a more streamlined, less complicated and faster route to finished goods. The invention described below relates to a dried fat emulsion which on reconstitution with water or other aqueous medium, enables the food manufacturer/preparer to rapidly and efficiently compose a wide variety of textured foods.

Instant reconstitutable powdered products are today, commonplace both domestically and in the food service area. They are used to prepare products as varied as soups, sauces, instant desserts, fruit drinks, and liquid diet foods, which contain a careful selection of both macro and micronutrients. One of the characteristics of these products is that they require either high temperature and or a large energy input in order to incorporate them into the chosen reconstituting liquid. There is an increasing demand from consumers for more and more time saving food preparation methods, coupled with a limited degree of a “do it yourself” input, and the whole experience can be optimised when there is a degree of fun involved.

The reason the powdered food market has not seen the growth it should is because the taste penalty associated with some of the products available on the market is perceived too great a trade off in the eyes of the consumer for the convenience of using them. Further, the act of reconstituting powders as foods has been more associated with a chore than that of having some fun. Powdery, cloying, mouthfeel effects are often quoted as being the undesired properties of such foods, and the flavour release is often hindered by the overwhelming presence of one particular component in the formulation which can have binding, and chelating effect on some crucial flavour chemicals. The subsequent re-use or delayed use of these reconstituted foods is often rendered impossible due to an irreversible structural change in the nature of the main texturising agents, as is the case in some complex carbohydrate rich foods, for example sauces made with native starch.

The extra weight that the presence of water brings to a product is a positively offset against its role in making foods succulent, and appetising. However the presence of water in processed foods can mean that the shelf life of foods is limited, and the transport and storage costs rise excessively.

For instance, low fat spreads of the “water-in-oil” type are often used as replacers for butter and margarine. In view of the general public concern about the adverse effects on health which fat-containing foodstuffs are said to have it has become desirable to produce butter-like products having as low a fat content as possible.

In GB-2,193,221 a low fat spread product is disclosed which is a water-in-oil emulsion comprising a continuous fat phase constituting 18-35 wt. % of the spread and for the rest a dispersed aqueous phase comprising at least 8 wt. % of milk proteins and 0.1-1.2 wt. % of a modified starch; the wt. % numbers are based on the total weight of the low fat spread.

Further, EP-0 558 523 B1 discloses finished foodstuffs like low fat spreads comprising bulk regions of a mesomorphic phase of edible surfactants and less than 70 wt. % edible oil, wherein the mesomorphic phase is a continuous phase and/or contains 80 wt. % or more of water. As illustrated in the examples of EP-0 558 523 B1 both zero-fat spreads and low fat spreads can be prepared. The water content in said spreads is very high, i.e. in the upper range of 94-95 wt. %.

As has been shown by the above-cited references the amount of water in low fat spreads can be raised to extremely high levels whilst the finished spread show a remarkable likeness to their high fat equivalents. However, the high water content must of course be carefully incorporated in the food matrix, and in general the more water the more difficult this process becomes.

In view of the low fat spreads known from the prior art it is stated that the high water content has a bearing on the transport costs and on the shelf stability of the spreads, from a microbiological point of view, especially if proteins are present as is desirable for taste reasons. Further the high water content can also be a cause of textural defects from the point of view of leakage, and sweating of the water phase.

A further aspect dominating the world of spreads is the requirement of the particular fatty material to actually melt and disperse in the mouth of the consumer, in order to fulfill the consumer expectations as far as flavour release and “melt down” are concerned. In geographical regions where the ambient temperatures are close to or are above that of mouth temperature the demands put on the margarine/spread¹ to be able to withstand these conditions often means that the fat composition is of such a nature that it does not readily melt in the mouth, and as such is less suitable for cold use such as a spreading. This is a difficult balancing act between storage stability and pleasant eating properties, and then use of these high melting point fat phases are a barrier to the growth of spreads for this cold use of “spreading” Margarine is minimum 80% fat, and a fat spread is understood as having less than 80% fat, from here forward the term spread will be used implying margarine like products having similar rheological chracteristics, i.e. a plastic solid (ref. Bingham model)

More particularly, the limitations of the prior art in low fat spreads can be seen as follows;

1. difficulty of incorporating the high water contents/water phases into the spread matrix

2. the high cost involved in transporting large amounts of water

3. the microbiological consequences of high water phase contents

4. textural problems associated with high water contents; and

5. the tropical margarine problem with high melting point fat phases.

Therefore, the one of the aims of the present invention was firstly directed to the development of a product solving the above-mentioned problems relating to the prior art low fat spreads.

Surprisingly it has been found that above problems can be circumvented by:

a) a powdered fat composition which

b) can be easily rehydrated in water, and

c) when placed in a refrigerator develops a plastic rheological texture similar to that of a fat spread (EU council regulation (EC) No. 2991/94b of Dec. 5, 1994 describes a spreadable fat or “solids fats” intended for human consumption as “products which remain solid at a temperature of 20° C., and which are suitable as spreads”); and

d) which spread has a pleasant “fast melt away” behaviour in the mouth.

More in particular the invention relates to a powdered fat composition comprising

10-80 wt. % crystallising fat

0.5-15 wt. % of one or more proteins, for the formation of the emulsion.

0.3-20 wt. % of an emulsifier, for the formation of the emulsion.

0.5-6 wt. % water, and

the balance is carbohydrate(s).

Further, the powdered fat composition may comprise 0-10 wt. % of a stabiliser, gelling agent, thickener, processing acid or a mixture thereof.

Preferably the crystallizing fat is of marine, vegetable, or dairy origin, and can be selected from the following fats, e.g. lauric fats, butter fat, palm oil, palm fat and fractions thereof as well as hydrogenated oils and fats, The amount of the crystallising fat is preferably 20-80 wt. % and most preferably 30-80 wt. %, and optimally 40-80% fat, calculated on the total weight of the fat composition according to the invention.

By the term “crystallising fats” is understood lipid based materials which exhibit a “solid fat:liquid oil” ratio over the temperatures range of use and preparation. This ratio when measured over a range of temperatures results in a melting curve. Methods which can be used to measure this melting curve are dilatometry and nuclear magnetic resonance (NMR). The use of NMR for this purpose was reported by Van Putte, K. and J. van den Enden, “Pulsed NMR as a quick method for the determination of the solid fat content in partly crystallised fats”. J. of Phys. E: Sci. Instr. 6 (1973) 910/12. Minispec Application note. Dr. H. Weisser, Institute of Food Process Engineering, University of Karlsruhe, Germany.

The proteins can be any protein type whether vegetable, or animal, or dairy. Suitable proteins are derived from milk such as casein or caseinates, or whey or concentrated solutions of these milk proteins. Proteins for instance of vegetable origin like soy, rice, pea, wheat and maize proteins are also suitable for the purposes of this invention. The amount of protein is preferably 1-15 wt. % and most preferably 3-15 wt. % and optimally 5-15% calculated on the total weight of the fat composition according to the invention.

Components aiding the powdering of the fat composition, and as adjuncts to the protein sources mentioned, like octenyl succinic acid (OSA) starches, and emulsifying plant extracts, like gum arabic, are mentioned which can also be applied to the fat composition to aid in the formation of the emulsion together with the protein source.

The emulsifier system present in the products according to the invention may be selected from a range of conventional products. Examples of conventional emulsifiers are mono- and diglycerides of fatty acids like the Admul MG and Myverol range of mono and diglycerides available from Quest International. Other emulsifiers which can aid in the formation of the emulsion are organic acid ester derivatives of mono and diglycerides e.g. acetoglycerides, (Acetem) lactoglycerides (Lactem) citroglycerides (Citrem) and diacetyl tartaric esters of monoglycerides, (Datem). Further emulsifiers suitable for use in the fat composition are polyglycerol esters of fatty acids, (Admul PGE) polyglycerol esters of condensed fatty acids from castor oil, (Admul WOL) propylene glycol esters of fatty esters, (Myverol P-06) sodium and calcium stearyl lactylates, (Admul SSL, and Admul CSL) sorbitan esters, (Span), and polysorbitan esters (Tween), lecithin and sucrose esters.

More particularly the emulsifier when selected from the mono or mono- and diglyceride types is characterised in that

about 90% of the fatty acids are C₁₆ or longer

and it has an iodine value of 20-115, preferably 25-115, and most preferably 30-115.

The amount of the abovementioned emulsifiers, either used singly or in combination is preferably 0.5-20 wt. % and most preferably 1-20 wt. %, and optimally 2-20%, calculated on the total weight of the fat composition.

The stabilisers may also be selected from conventional products like vegetable, animal and fermented hydrocolloid stabilisers examples of which are xanthan gum, guar gum, modified guar gum, alginates, carrageenan, semi-refined carrageenan, locust bean gum, tara gum, pectin, agar. The fermented milk solids containing exopolysaccharides such as Enrich 221 (registered trademark of Quest International), may also be selected. Gelatine from animal and marine sources may also be chosen to be incorporated into the fat composition according to the invention. Starches and their derivatives e.g. maltodextrins may also be selected for incorporation into the fat composition according to the invention.

The amount of a high viscosity stabiliser is preferably 0-3 wt. % and most preferably 0-2.5 wt. % and optimally 0-2%, calculated on the total weight of the fat composition according to the invention.

Further conventional additives such as salts, pH regulating agents, chemical preservatives, potassium sorbate as a preservative and citrates and phosphates, as stabilisers, and free flowing agents, may also be added to the products according to the invention. The additives are added in varying amounts, typically totalling 0.01 to 5 wt. % of the product; a person skilled in the art will readily be able to determine the optimum amounts of each additive.

The dried powdered fat emulsion product can be used for the production of many products like for instance the abovementioned low fat spreads but also for the preparation of other food products like mousse, topping cream, and whipped cream, and dip products as well as for the preparation of non-food products like cosmetic compositions. Amongst the applications for which the use of this fat composition have been found are ice cream, sorbet ice, sherbet, heat treated spreads, (both UHT and pasteurised) for example chocolate spreads, cheese and margarine like spreads. Cold processed products include the following, fruit and vegetable juice dips and spreads, vegetable based “liver flavoured” pate, mayonnaise flavoured dips. Traditional foods can also be transformed using the fat composition, and examples of these are clotted cream type textures, and spreads based on yogurt and buttermilk.

With respect to the mousse products it has been found that the animal gelatine present in “ready to eat” mousse products, (which gelatine is desirable to be replaced especially with respect to the recent health concerns arising from diseases to cattle) can easily be replaced by the powdered fat composition according to the invention; see Examples 3 and 4 shown below.

Another popular means of applying a succulent, unctuous dressing to a baked good or a portion of a sliced vegetable is by dipping. Such a dip or dip sauce can simply be made by shaking an amount of the powdered fat composition according to the invention with a pre-determined quantity of aqueous based liquid. A smooth salve like substance will be obtained within seconds, (in a period of time ranging from 1 to 30 seconds) having pleasant eating qualities, coupled with excellent textural qualities, in so far as it has sufficient internal cohesiveness and cling properties, that it can be readily used as a dip. Further the surprising aspect of this invention is that when this dip product is refrigerated to about 5° C. for a sufficient time this texture transforms into a solid spreadable mass with obvious plastic rheological properties.

Concerning cosmetic compositions it is stated that for instance creams can be made on the basis of the powdered fat composition according to the invention having excellent properties. More in particular all kinds of oils can be applied like almond oil together with the fragrances considered appropriate for the specific personal case application. In this way it is also possible to use base ingredients that are perceived to be more user friendly for both skin and hair treatments. The advantage of these type of cosmetic preparations is the convenience of being able to “mix it up yourself” at home as you need it, using water or dairy liquids, such as buttermilk for added skin benefits, or for use in store, where it could be “tailored” to the individual customer's needs at the time. “Mass customisation” is increasingly being recognised as a trend in the cosmetics market, and the subject of the invention lends itself readily to this end. Fresh, unpreserved products that you store in the fridge and have a short “use by” date, are also a trend, to which use the fat composition according to the invention can also be put.

Another aspect of the invention is a process for the preparation of a dried powdered fat emulsion product comprising the steps of

dissolving the water soluble ingredients in water;

dissolving the fat soluble/dispersable ingredients in the fat phase;

adding the fat phase to the water and forming an emulsion by homogenizing; and

spray drying the obtained emulsion.

In Table A, an example is given of the products suitable for performing the invention.

TABLE A

| | % in emulsion for | App. % in the final |
|---|---|---|
| Product | spray drying | powder |
| Water | To 100% | Max 3% |
| Vegetable fat | 33 | App 65% |
| Whey powder | 16 | App. 30 |
| Minor ingredients | 0.2 | App. 0.4 |
| e.g. preservatives, | | |
| acids | | |
| Myvatex cream | 2.5 | App. 5.0 |
| base 52** | | |

**Myvatex Cream base 52 is an emulsifier/stabiliser system made up of mono and diglycerides of fatty acids, and vegetable and hydrocolloid stabilisers such as xanthan gum, guar gum and carrageenan, together with some stabilising phosphates.

In the case of a low fat spread the dried powdered fat emulsion product according to the invention can be processed as follows:

The fat composition is rehydrated by way of applying sufficient shear, with such an amount of water necessary to obtain the desired water content of the low fat spread; such that the powder is fully wetted and a smooth paste like consistency has been achieved and cooling the obtained dehydrated product to refrigeration temperatures below about 10° C., for instance at about 5° C. to a product which final texture is that of a plastic solid. The produced low fat spread has a water content of 50-90 wt. %, preferably 60-85 wt. %; a fat content of at least 12 wt. %, preferably at least 15 wt. % and most preferably at least 17.5 wt. % and a hardness reading of approximately 180-220, preferably about 200 measured on a Stevens texture analyser.

The invention is elucidated by means of the following examples, but should not be limited thereto.

### EXAMPLES 1

Three powders were produced by spray drying the following emulsion recipes defined in Table B. The amounts are given in wt. %.

TABLE B

| | Powder 1 % | Powder 2 % | Powder 3 % |
|---|---|---|---|
| Water | To 100% | To 100% | To 100% |
| Vegetable fat | 30 | 30 | 20 |
| Myvatex Cream base 51* | 2.0 | 2.0 | |
| Emulsifier blend** | | | 10 |
| Skimmed milk powder | 16 | 0 | 19 |
| Whey powder | 0 | 16 | |

*Myvatex Cream Base 51 is an emulisfier/stabiliser system made by Quest International, and composed of mono and diglycerides of fatty acids and vegetable and hydrocolloid stabilizers.
**The emulsifier blend is an emulsifier system composed of monoglycerides and polyglycolesters of fatty acids (PGMS).

The above water soluble ingredients were dissolved in the available water, and the fat soluble ingredients melted with the vegetable fat. The two phases were mixed together and subsequently homogenized in a Rannie apparatus and spray-dried in an Anhydro spray drying apparatus at an inlet temperature of 170° C.

After rehydration of 25 g of the spray-dried powder 1, in 75 g of cold water and cooling to refrigeration temperature (5° C.) the resultant texture of the product was that of a solid having a hardness of about 200 grams on a Stevens texture analyser.

### EXAMPLE 2

After rehydration of 30 g of the spray dried powder 2 in table B above, with 70 g of cold water, and cooling to refrigeration temperature (5° C.) the resultant texture of the product was that of a solid having a hardness of about 200 grams on a Stevens texture analyser. The addition of a butter like flavour, salt and some carotene colour to the mix, resulted in a yellow fat type spread remarkably resembling that of low fat margarine, in both taste and texture.

### EXAMPLE 3

A mousse product was prepared on the basis of the following recipe:

| | |
|---|---|
| Myvatex Mighty Spread* | 12.0 wt. % |
| Sucrose | 16.0 wt. % |
| Skim milk powder | 4.0 wt. % |
| Cocoa powder | 4.0 wt. % |
| Black chocolate flavour | 0.3 wt. % |
| Full milk | balance |

*Myvatex Mighty Spread is a registered product marketed by Quest International and has a composition equivalent to powder 1 in table B above.

The processing is carried out by heating the milk to 75° C. Then all the dry ingredients were added under stirring to the heated milk until the ingredients were dissolved therein. The obtained solution was subsequently pasteurised at 82° C. for 20 seconds and cooled to 20° C. A further cooling and an aerating of the obtained product was carried out in a Mondomix machine to approximately 100% overrun, followed by refrigeration at 5° C.

### EXAMPLE 4

A mousse product was also prepared according to the following recipe

| | |
|---|---|
| Myvatex* Mighty Whip | 6.0% |
| Sucrose | 16% |
| Skim Milk powder | 4.0% |
| Cocoa powder | 4% |
| Flavour | 0.3% |
| Full milk | Balance |

*Myvatex is a registered brand name of Quest International, and Myvatex Mighty Whip is a powder, which has a composition equivalent to that of powder 3 in Tabel B above..

The processing is carried out by heating the milk to 75° C. Then all the dry ingredients were added under stirring to the heated milk until the ingredients were dissolved therein. The obtained solution was subsequently pasteurised at 82° C. for 20 seconds and cooled to 20° C. A further cooling and an aerating of the obtained product was carried out in a Mondomix machine to approximately 100% overrun, followed by refrigeration at 5° C.

The products obtained had a spoonable texture similar to a conventional mousse made with gelatine of animal origin.

### EXAMPLE 5

A dip sauce was prepared on the basis of the following recipe:

| | |
|---|---|
| Myvatex Mighty Cream* | 17 g |
| Cold tap water | 33 g |
| Cream & Chives flavouring. | 1 g |

*Myvatex Mighty Cream is a registered product marketed by Quest International, which has a composition similar to powder 2 described in table B above.

The above components were shaken together by hand in a lidded container, for 12-20 seconds, and the result was a smooth shiny cohesive and viscous salve like consistency, which had excellent flavour release characteristics.

If refrigerated at 5° C. for a sufficient period of time, the dip sauce transformed into a solid spread having plastic rheological properties.

### EXAMPLE 6

A fruit juice spread was prepared according to the following recipe.

| | |
|---|---|
| Myvatex Mighty Cream | 25 g |
| Fruit juice (mango) | 75 g |

The hydrated Myvatex Mighty Cream powder was placed under refrigeration, and after a few hours at 5° C. the mix assumed a spreadable texture. The spread did not exude water and remained as a cohesive mass under the shear exerted by the knife.

### EXAMPLE 7

Powder formula for chocolate spread:

| | wt. % |
|---|---|
| Myvatex Mighty Spread | 60.0 |
| Sugar | 32.5 |
| Cocoa powder | 5.0 |
| Cocoa Powder flavouring 2M60509* | 1.5 |
| Hazelnut Caps flavouring DU64770* | 1.0 |

*products marketed by Quest International

The processing is carried out by adding 40% by weight the above ingredients to hot water under using a high shear Silverson mixer, and then the mix was filled into containers and pasteurised.

The emulsion on cooling to 5° C. assumed a firm spreadable texture.

### EXAMPLE 8

The following cosmetic creams utilising Myvatex Mighty Spread and Myvatex Mighty Cream were prepared by cold mixing and were evaluated after setting in a fridge at 5° C.:

| Ingredient | 1 % | 2 | 3 | 4 | 5 | 6 | 7 |
|---|---|---|---|---|---|---|---|
| Myvatex Mighty Spread* | 40 | — | 40 | — | 40 | 40 | 40 |
| Myvatex Mighty Cream* | — | 40 | — | 40 | — | — | — |
| Water | 60 | 60 | 57 | 57 | 55 | 50 | 45 |
| Refined Almond Oil | — | — | 3 | 3 | 5 | 10 | 15 |

*Myvatex Mighty Spread and Myvatex Mighty Cream are registered products from Quest International and have a composition similar to powder 1 and powder 2 in Table B above respectively.

The evaluation of the creams was as follows, compared with a conventional, hot mix moisturising cream Quest formulation QA 1272:

A numerical 1-5 scale was used to rate the following attributes:

1. Relative stiffness of the cream, where 1 is quite liquid and 5 represents a solid, stiff cream.

2. Ease of spreading on the skin, where 1 represents very poor spreading, ranging up to 5 where spreading is extremely easy.

3. Ease of rub-in-1 is poor up to 5 being excellent.

4. Skin feel after rub-in-1 is greasy and unpleasant, ranging up to 5 which is smooth, non-greasy skin feel.

Results

| Cream Code | Stiffness | Spreading | Rub-in | Skin feel |
|---|---|---|---|---|
| 1 | 3 | 4 | 4 | 4 |
| 2 | 2 | 3 | 3 | 2.5 |
| 3 | 2.5 | 4 | 4 | 4 |
| 4 | 2 | 2 | 2 | 2 |
| 5 | 3 | 5 | 3 | 4 |
| 6 | 3 | 5 | 4 | 4 |
| 7 | 2.5 | 5 | 2 | 3 |
| Standard | 4 | 4 | 3.5 | 4 |

The Myvatex creams are easy to make by low shear mixing.

The skin feel on initial application of all products is quite cooling as the water evaporates and the fat melts. Myvatex Mighty Spread would appear to produce better products than the Myvatex Mighty Cream.

The presence of around 5-10% almond oil appears to be a good starting point for reasonable products with good rub-in characteristics and residual skin feel.

### EXAMPLE 9

An ice cream product was produced according to the following recipe:

Formula:

| | wt. % |
|---|---|
| Myvatex Mighty Spread | 10.0 |
| Dextrose monohydrate | 2.0 |
| Maltodextrin MD 20 | 8.0 |
| Sucrose | 12.0 |
| Skim milk powder | 6.0 |
| Flavour | 0.1 |
| Water Balance | |

The processing is carried out by heating the water to 75° C. Then all the dry ingredients were added under stirring to the water until the ingredients were dissolved therein. The obtained solution was subsequently pasteurised at 82° C. for 20 seconds and cooled to 20° C. A further cooling and aerating of the obtained product was carried out in an ice cream machine to the desired overrun and temperature, followed by hardening in a blast freezer and storing in a freezer at −20° C.

No homogenisaton or ageing required and the ice cream had pleasant eating qualities together with excellent meltdown characteristics.

1. Powdered fat composition comprising
10-80 wt. % crystallising fat
0.5-15 wt. % of one or more proteins,
0.3-20 wt. % of an emulsifier,
0.5-6 wt. % water,
and the balance is made up of carbohydrate(s).

2. Powdered fat composition according to claim 1, wherein the composition comprises 0.0-10 wt. % of a stabiliser, gelling agent, thickener, processing aid or a mixture thereof.

3. Powdered fat composition according to claim 1 or 2, wherein the crystallising fat of marine, animal, or vegetable origin is used either singly or in combinations, and is selected from the group consisting of lauric fat, butter fat, palm oil, palm fat and fractions hydrogenated fats and oils of the types named above.

4. Powdered fat composition according to any of the claims 1-3, wherein the protein is selected from vegetable, animal, or dairy origin used either singly or in combination.

5. Powdered fat composition according to claim 4, wherein the protein is selected from the group consisting of dairy derived proteins, a solution of sodium caseinate or skimmed milk or skimmed milk powder, a protein concentrate obtained from soured skimmed milk or buttermilk, a whey powder or whey concentrate based powder, a protein derived from soya, rice and pea, wheat, and maize and mixtures thereof.

6. A process for the preparation of a powdered fat composition according to any of the previous claims comprising the steps of
dissolving the water soluble ingredients in water;
dissolving the fat soluble/dispersable ingredients in the fat phase;
adding the fat phase to the water and forming an emulsion by homogenizing; and
spray drying the obtained emulsion.

7. A food or non-food composition obtained by hydrating the product defined in claims 1-5 or prepared by the process according to claim 6 and refrigerating the obtained hydrated product at a temperature below about 10° C. resulting in a product having a water content of 50-90 wt. %, preferably 60-85 wt. %.

8. A food or non-food composition according to claim 7, having a fat content of at least 12 wt. %, preferably at least 15 wt. % and most preferably at least 17.5 wt. %.

9. A dip sauce composition obtained by shaking the product defined in claims 1-5 or prepared by the process according to claim 6 with an aqueous liquid for a sufficient period of time ranging from 1 to 30 seconds, to produce an instantly consumable substance.

10. A mousse composition obtained by mixing the product defined in claims 1-5 or prepared by the process according to claim 5 with an aqueous liquid, followed by pasteurising, cooling, aerating and finally refrigerating the obtained product.
